(19) United States
(12) Patent Application Publication
(10) Pub. No.: US 2016/0094068 A1
(43) Pub. Date: Mar. 31, 2016

(54) SECONDARY BATTERY PROTECTION CIRCUIT AND BATTERY DEVICE

(71) Applicant: Seiko Instruments Inc., Chiba-shi (JP)

(72) Inventor: Fumihiko MAETANI, Chiba-shi (JP)

(21) Appl. No.: 14/862,728

(22) Filed: Sep. 23, 2015

(30) Foreign Application Priority Data
Sep. 26, 2014 (JP) 2014-197241

(51) Int. Cl. H02J 7/00

(52) U.S. Cl. CPC H02J 7/0031; H02J 7/007; H02J 2007/0037

(57) ABSTRACT

To realize an overcharge detection device capable of bring about a state of reducing current consumption thereof except for when a lithium ion secondary battery becomes overcharged, and provide a secondary battery protection circuit and a battery device low in power consumption and safe. There is provided a secondary battery protection circuit which is provided with a second detection circuit having a detection voltage threshold identical to or lower than a detection voltage threshold of an overcharge detection circuit and reduces current consumption of the overcharge detection device when the voltage of the secondary battery is less than the detection voltage threshold of the second detection circuit.

### RELATED APPLICATIONS

This application claims priority under 35 U.S.C. §119 to Japanese Patent Application No. 2014-197241 filed on Sep. 26, 2014, the entire content of which is hereby incorporated by reference.

### BACKGROUND OF THE INVENTION

1. Field of the Invention

The present invention relates to a secondary battery protection circuit for preventing overcharging and overcurrent of a battery pack using a protective element having a heating resistor and a fuse element both provided over a substrate, and a control switch, and a battery device.

2. Description of the Related Art

Along with the spread of mobile electronic devices such as a cellular phone, a notebook personal computer, etc., the market of a lithium ion secondary battery has been expanded. In these mobile electronic devices, a battery pack having one to plural lithium ion secondary batteries connected in series has normally been used as a power supply. When each of the lithium ion secondary batteries becomes overcharged in charging in such a battery pack, there is a possibility of catching a fire or smoke generation. A secondary battery protection circuit is provided to prevent the possibility.

The secondary battery protection circuit protects the lithium ion secondary battery against both of overcurrent and overcharging. The secondary battery protection circuit is comprised of a protective element having a heating resistor and a fuse element provided over a substrate, an overcharge detection device which detects the overcharging, and a control switch which causes current to flow through the protective element. The secondary battery protection circuit blows out the fuse element at overcurrent and thereby protects the secondary battery from the overcurrent. During overcharging, the overcharge detection device detects the overcharging of the secondary battery and turns ON the control switch. Then, the current is made to flow through the heating resistor to blow out the fuse element by heat generated thereat, thereby protecting the secondary battery from overcharging.

Further, there is also a case where charge/discharge control of the secondary battery protection circuit is configured by a plurality of control switches. The lithium ion secondary battery is protected using a switch for the overcharge detection device and its charge control in addition to a switch for the secondary battery protection circuit and its charge control, and a discharge control switch.

The overcharge detection device monitors the voltage of the lithium ion secondary battery and may be operated only at the detection of overcharging. Therefore, a standby circuit is provided within the overcharge detection device to reduce current consumption where another secondary battery protection circuit is brought into an overdischarge state or a discharge overcurrent state, thereby realizing protection of the lithium ion secondary battery against the overcharging with low power consumption (refer to, for example, Patent Document 1).

[Patent Document 1] Japanese Patent Application Laid-Open No. 2012-65392

### SUMMARY OF THE INVENTION

In the related art, the standby circuit has been provided within the overcharge detection device to reduce the current consumption where the overdischarge state or the discharge overcurrent state is reached. Therefore, when another secondary battery protection circuit is not brought into the overdischarge state or the discharge overcurrent state, the overcharge detection circuit is in operation and consuming power. The overcharge detection circuit was accompanied by a problem that the overcharge detection circuit might be operated when the lithium ion secondary battery became overcharged, but would consume power in normal operation other than that.

The present invention has been invented to solve the above-described problem. An object of the present invention is to realize an overcharge detection device capable of bringing about a state of reducing current consumption of the overcharge detection device except for when a lithium ion secondary battery becomes overcharged, and provide a secondary battery protection circuit and a battery device which are low in power consumption and safe.

In order to solve the above-described problem, there is provided in the present invention, a second detection circuit having a detection voltage threshold identical to a detection voltage threshold of an overcharge detection circuit or lower than that in the vicinity of the detection voltage threshold of the overcharge detection circuit. When the voltage of a secondary battery is less than the detection voltage threshold of the second detection circuit, the overcharge detection circuit and other circuits are brought into a state of being free from the consumption of power.

According to a secondary battery protection circuit of the present invention, since current consumption of an overcharge detection device can be reduced except for when a lithium ion secondary battery becomes overcharged, a secondary battery protection circuit and a battery device low in power consumption and safe can be provided.

### BRIEF DESCRIPTION OF THE DRAWINGS

FIG. 1 is a circuit diagram of a battery device of a first embodiment;

FIG. 2 is a circuit diagram of a battery device of a second embodiment;

FIG. 3 is a circuit diagram of a battery device of a third embodiment; and

FIG. 4 is a circuit diagram of a battery device of a fourth embodiment.

### DETAILED DESCRIPTION OF THE PREFERRED EMBODIMENTS

Preferred embodiments will hereinafter be described with reference to the accompanying drawings.

### First Embodiment

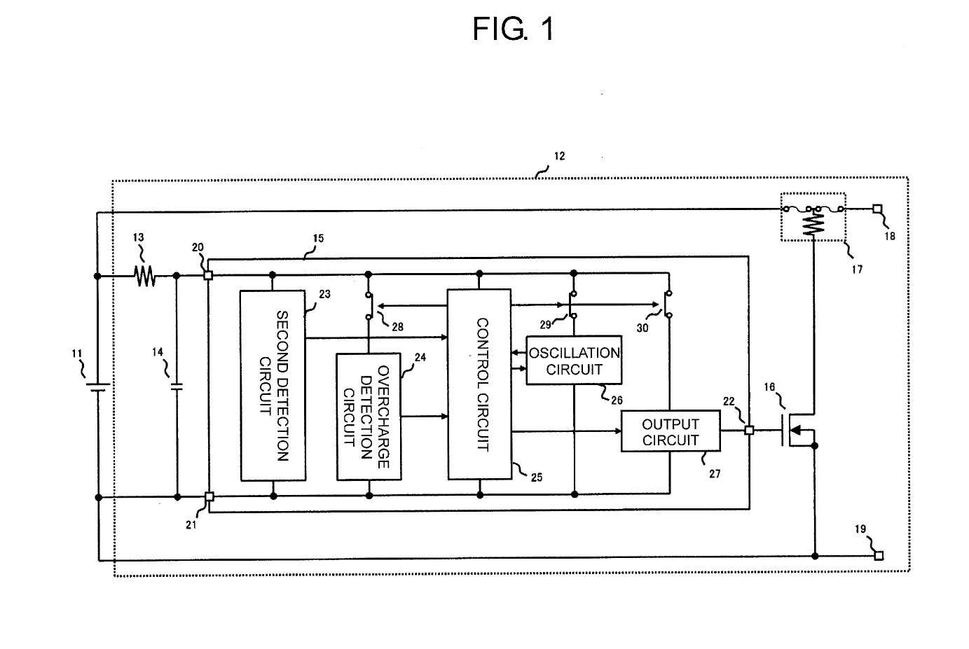

FIG. 1 is a circuit diagram of a battery device of a first embodiment.

The battery device of the first embodiment is comprised of a secondary battery 11 and a secondary battery protection circuit 12. The secondary battery protection circuit 12 is comprised of a resistor 13, a capacitor 14, an overcharge detection device 15, an Nch control switch 16, a protective element 17, and external terminals 18 and 19. The protective element 17 has a heating resistor and a fuse element provided over a substrate. The heating resistor generates heat by electric conduction to thereby blow out the fuse element.

The overcharge detection device 15 is comprised of a positive electrode power supply terminal 20, a negative electrode power supply terminal 21, an output terminal 22, an overcharge detection circuit 24, a second detection circuit 23, a control circuit 25, an oscillation circuit 26, an output circuit 27, and switches 28, 29 and 30.

A positive electrode of the secondary battery 11 is connected to one terminals of the fuse element of the protective element 17 and the resistor 13. A negative electrode of the secondary battery 11 is connected to one terminal of the capacitor 14, the negative electrode power supply terminal 21, a source and a back gate of the Nch control switch 16, and the external terminal 19. The other terminal of the fuse element of the protective element 17 is connected to the external terminal 18. The positive electrode power supply terminal 20 is connected to the other terminals of the resistor 13 and the capacitor 14. The output terminal 22 is connected to a gate of the Nch control switch 16. A drain of the Nch control switch 16 is connected to the heating resistor of the protective element 17. Further, while the overcharge detection circuit 24, the second detection circuit 23, the control circuit 25, the oscillation circuit 26, and the output circuit 27 are arranged inside the overcharge detection device 15 so as to be included between the positive electrode power supply terminal 20 and the negative electrode power supply terminal 21, the overcharge detection circuit 24, the oscillation circuit 26, and the output circuit 27 are respectively connected to the positive electrode power supply terminal 20 via switches. Incidentally, the switches may be provided on the negative electrode power supply terminal 21 side.

The operation of the battery device of the first embodiment will next be described.

When the voltage of the secondary battery 11 is less than or equal to an overcharge detection voltage set by the overcharge detection circuit 24, the output circuit 27 outputs a negative electrode power supply terminal potential to turn OFF the Nch control switch 16. In this case, if a load or a charger is connected between the external terminals 18 and 19, current can be made to flow therethrough to bring about a chargeable/dischargeable state.

A detection voltage of the second detection circuit 23 is less than or equal to the overcharge detection voltage and is set to a voltage as high as possible.

When the voltage of the secondary battery 11 is high and greater than or equal to the detection voltage of the second detection circuit 23, the switches 28, 29, and 30 are turned ON to start the overcharge detection circuit 24, the oscillation circuit 29, and the output circuit 27. Further, when the voltage of the secondary battery 11 rises and exceeds the overcharge detection voltage, the overcharge detection circuit 24 outputs a detection signal to output a positive electrode power supply terminal potential from the output terminal 22 of the overcharge detection device 15, thereby turning ON the Nch control switch 16. Then, the current is made to flow through the heating resistor of the protective element 17 to blow out the fuse element of the protective element 17 by heat generated thereat, thereby protecting the secondary battery 11 from overcharging.

When the second detection circuit 23 does not detect the set voltage, the control circuit 25 turns OFF the switches 28, 29, and 30. In the case of this state, the negative electrode power supply terminal potential is outputted from the output terminal 22. By doing this, power consumption of the overcharge detection device 15 can be reduced in most situations that the secondary battery 11 is being used.

As described above, it is possible to realize an overcharge detection device capable of bringing about a state of reducing current consumption of the overcharge detection device except for when the lithium ion secondary battery becomes overcharged, and provide a secondary battery protection circuit and a battery device which are low in power consumption and safe.

### Second Embodiment

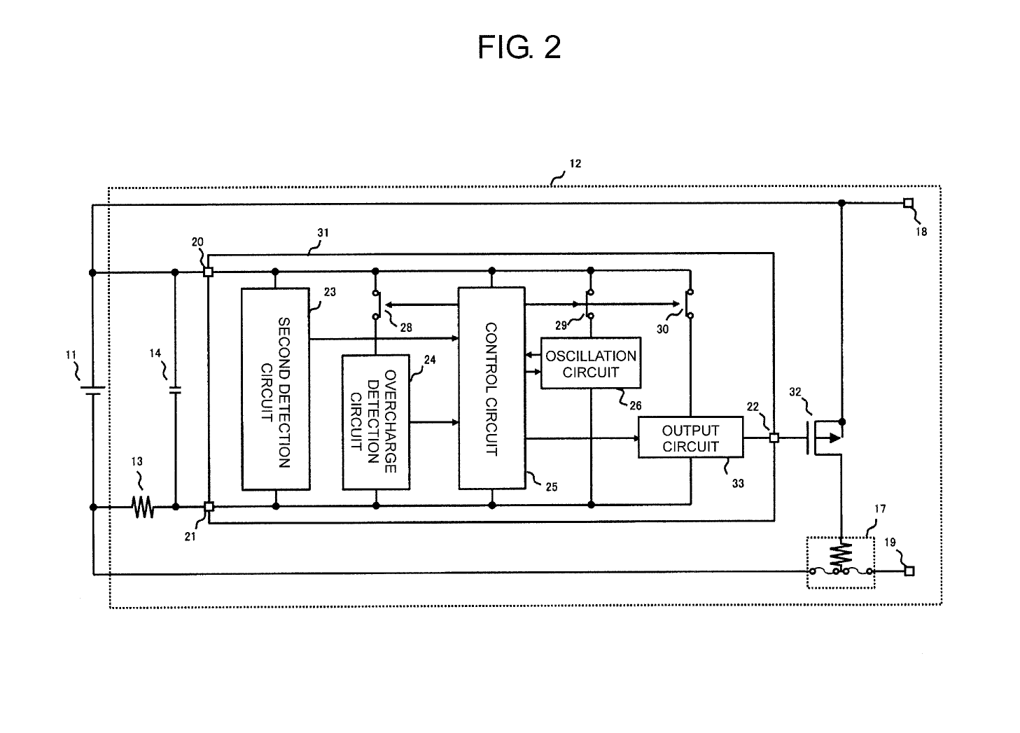

FIG. 2 is a circuit diagram of a battery device of a second embodiment.

The battery device of the second embodiment is comprised of a secondary battery 11 and a secondary battery protection circuit 12. The secondary battery protection circuit 12 is comprised of a resistor 13, a capacitor 14, an overcharge detection device 31, a Pch control switch 32, a protective element 17, and external terminals 18 and 19. The protective element 17 has a heating resistor and a fuse element provided over a substrate. The heating resistor generates heat by electric conduction to thereby blow out the fuse element.

The overcharge detection device 31 is comprised of a positive electrode power supply terminal 20, a negative electrode power supply terminal 21, an output terminal 22, an overcharge detection circuit 24, a second detection circuit 23, a control circuit 25, an oscillation circuit 26, an output circuit 33, and switches 28, 29 and 30.

A negative electrode of the secondary battery 11 is connected to one terminals of the fuse element of the protective element 17 and the resistor 13. A positive electrode of the secondary battery 11 is connected to one terminal of the capacitor 14, the positive electrode power supply terminal 20, a source and a back gate of the Pch control switch 32, and the external terminal 18. The other terminal of the fuse element of the protective element 17 is connected to the external terminal 19. The negative electrode power supply terminal 21 is connected to the other terminals of the resistor 13 and the capacitor 14. The output terminal 22 is connected to a gate of the Pch control switch 32. A drain of the Pch control switch 32 is connected to the heating resistor of the protective element 17. Further, while the overcharge detection circuit 24, the second detection circuit 23, the control circuit 25, the oscillation circuit 26, and the output circuit 33 are provided between the positive electrode power supply terminal 20 and the negative electrode power supply terminal 21 so as to be included inside the overcharge detection device 31, the overcharge detection circuit 24, the oscillation circuit 26, and the output circuit 33 are respectively connected to the positive electrode power supply terminal 20 via switches. Incidentally, the switches may be provided on the negative electrode power supply terminal 21 side.

The operation of the battery device of the second embodiment will next be described.

When the voltage of the secondary battery 11 is less than or equal to an overcharge detection voltage set by the overcharge detection circuit 24, the output circuit 33 outputs a positive electrode power supply terminal potential to turn OFF the Pch control switch 32. In this case, if a load or a charger is connected between the external terminals 18 and 19, current can be made to flow therethrough to bring about a chargeable/dischargeable state.

A detection voltage of the second detection circuit 23 is less than or equal to the overcharge detection voltage and is set to a voltage as high as possible.

When the voltage of the secondary battery 11 is high and greater than or equal to the detection voltage of the second detection circuit 23, the switches 28, 29, and 30 are turned ON to start the overcharge detection circuit 24, the oscillation circuit 29, and the output circuit 33. Further, when the voltage of the secondary battery 11 rises and exceeds the overcharge detection voltage, the overcharge detection circuit 24 outputs a detection signal to output a negative electrode power supply terminal potential from the output terminal 22 of the overcharge detection device 31, thereby turning ON the Pch control switch 32. Then, the current is made to flow through the heating resistor of the protective element 17 to blow out the fuse element of the protective element 17 by heat generated thereat, thereby protecting the secondary battery 11 from overcharging.

When the second detection circuit 23 does not detect the set voltage, the control circuit 25 turns OFF the switches 28, 29, and 30. In the case of this state, the positive electrode power supply terminal potential is outputted from the output terminal 22. By doing this, power consumption of the overcharge detection device 31 can be reduced in most situations that the secondary battery 11 is being used.

As described above, it is possible to realize an overcharge detection device capable of bringing about a state of reducing current consumption of the overcharge detection device except for when the lithium ion secondary battery becomes overcharged, and provide a secondary battery protection circuit and a battery device which are low in power consumption and safe.

### Third Embodiment

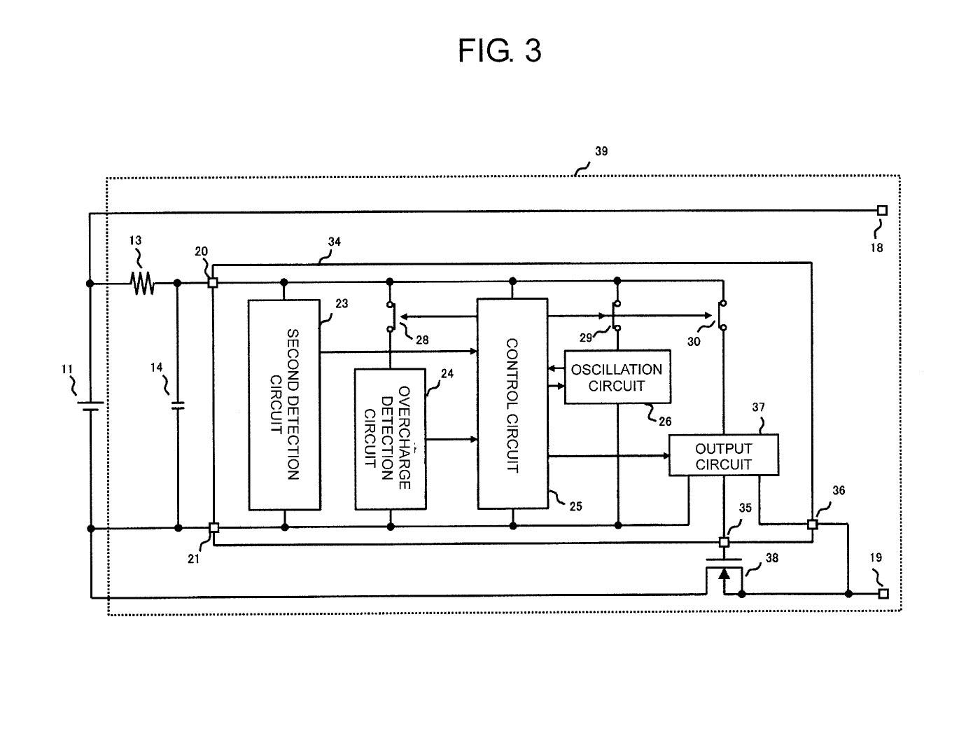

FIG. 3 is a circuit diagram of a battery device of a third embodiment.

The battery device of the third embodiment is comprised of a secondary battery 11 and a secondary battery protection circuit 39. The secondary battery protection circuit 39 is comprised of a resistor 13, a capacitor 14, an overcharge detection device 34, an Nch charge control switch 38, and external terminals 18 and 19.

The overcharge detection device 34 is comprised of a positive electrode power supply terminal 20, a negative electrode power supply terminal 21, an external terminal voltage input terminal 36, an output terminal 35, an overcharge detection circuit 24, a second detection circuit 23, a control circuit 25, an oscillation circuit 26, an output circuit 37, and switches 28, 29 and 30.

A positive electrode of the secondary battery 11 is connected to one terminal of the resistor 13 and the external terminal 18. A negative electrode of the secondary battery 11 is connected to one terminal of the capacitor 14, the negative electrode power supply terminal 21, and a drain of the Nch charge control switch 38. A source and a back gate of the Nch charge control switch 38 are connected to the external terminal voltage input terminal 36 and the external terminal 19. The positive electrode power supply terminal 20 is connected to a connection point of the resistor 13 and the capacitor 14. The output terminal 35 is connected to a gate of the Nch charge control switch 38. Further, the overcharge detection circuit 24, the second detection circuit 23, the control circuit 25, and the oscillation circuit 26 are provided between the positive electrode power supply terminal 20 and the negative electrode power supply terminal 21 so as to be included inside the overcharge detection device 34. The output circuit 37 is operated between the positive electrode power supply terminal 20 and the negative electrode power supply terminal 21 and also connected to the external terminal voltage input terminal 36. Positive electrode power supplies of the overcharge detection circuit 24, the oscillation circuit 26, and the output circuit 37 are respectively connected to the positive electrode power supply terminal 20 through the switches. Incidentally, the switches may be provided on the negative electrode power supply terminal 21 side.

The operation of the battery device of the third embodiment will next be described.

When the voltage of the secondary battery 11 is less than or equal to an overcharge detection voltage set by the overcharge detection circuit 24, the output circuit 37 outputs a positive electrode power supply terminal potential to turn ON the Nch charge control switch 38. In this case, if a load or a charger is connected between the external terminals 18 and 19, current can be made to flow therethrough to bring about a chargeable/dischargeable state.

A detection voltage of the second detection circuit 23 is less than or equal to the overcharge detection voltage and is set to a voltage as high as possible.

When the voltage of the secondary battery 11 is high and greater than or equal to the detection voltage of the second detection circuit 23, the switches 28, 29, and 30 are turned ON to start the overcharge detection circuit 24, the oscillation circuit 29, and the output circuit 37. Further, when the voltage of the secondary battery 11 rises and exceeds the overcharge detection voltage, the overcharge detection circuit 24 outputs a detection signal to output an external terminal voltage input terminal potential from the output terminal 35 of the overcharge detection device 34, thereby turning OFF the Nch charge control switch 38. Then, a charging current path is cut off to protect the secondary battery 11 from overcharging.

When the second detection circuit 23 does not detect the set voltage, the control circuit 25 turns OFF the switches 28, 29, and 30. In the case of this state, the positive electrode power supply terminal potential is outputted from the output terminal 35. By doing this, power consumption of the overcharge detection device 34 can be reduced in most situations that the secondary battery 11 is being used.

As described above, it is possible to realize an overcharge detection device capable of bringing about a state of reducing current consumption of the overcharge detection device except for when the lithium ion secondary battery becomes overcharged, and provide a charging control device and a battery device which are low in power consumption and safe.

### Fourth Embodiment

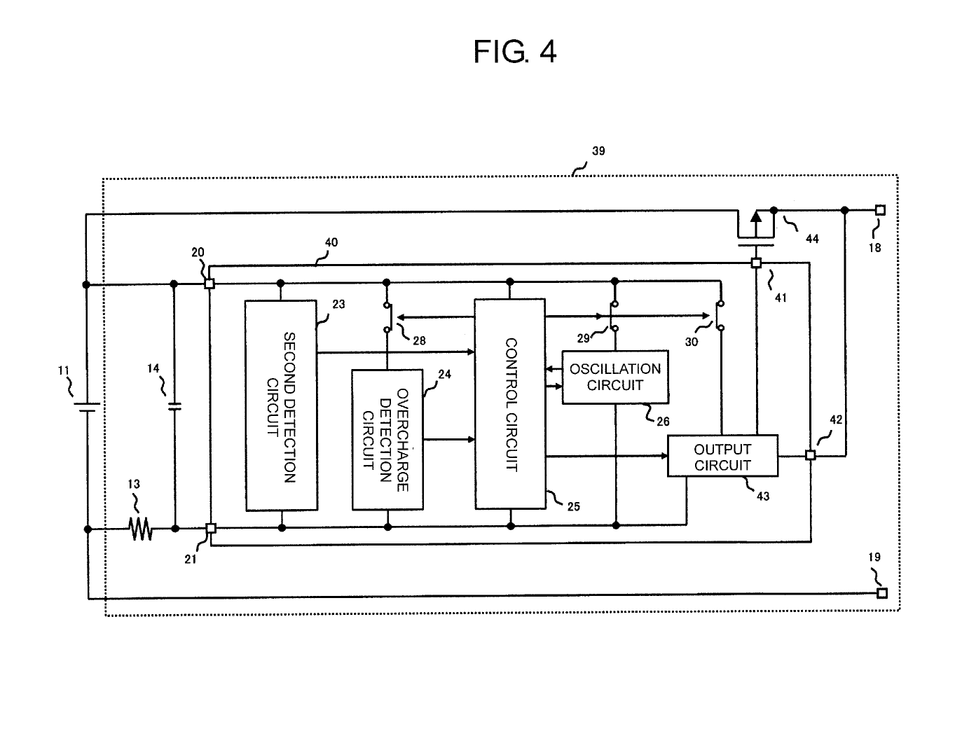

FIG. 4 is a circuit diagram of a battery device of a fourth embodiment.

The battery device of the fourth embodiment is comprised of a secondary battery 11 and a secondary battery protection circuit 39. The secondary battery protection circuit 39 is comprised of a resistor 13, a capacitor 14, an overcharge detection device 40, a Pch charge control switch 44, and external terminals 18 and 19.

The overcharge detection device 40 is comprised of a positive electrode power supply terminal 20, a negative electrode power supply terminal 21, an external terminal voltage input terminal 42, an output terminal 41, an overcharge detection circuit 24, a second detection circuit 23, a control circuit 25, an oscillation circuit 26, an output circuit 43, and switches 28, 29 and 30.

A negative electrode of the secondary battery 11 is connected to one terminal of the resistor 13 and the external terminal 19. A positive electrode of the secondary battery 11 is connected to one terminal of the capacitor 14, the positive electrode power supply terminal 20, and a drain of the Pch charge control switch 44. A source and a back gate of the Pch charge control switch 44 are connected to the external terminal voltage input terminal 42 and the external terminal 18. The negative electrode power supply terminal 21 is connected to the other terminals of the resistor 13 and the capacitor 14. The output terminal 41 is connected to a gate of the Pch charge control switch 44. Further, the overcharge detection circuit 24, the second detection circuit 23, the control circuit 25, and the oscillation circuit 26 are provided between the positive electrode power supply terminal 20 and the negative electrode power supply terminal 21 so as to be included inside the overcharge detection device 40. The output circuit 43 is operated between the positive electrode power supply terminal 20 and the negative electrode power supply terminal 21 and connected to the external terminal voltage input terminal 42. Positive electrode power supplies of the overcharge detection circuit 24, the oscillation circuit 26, and the output circuit 43 are respectively connected to the positive electrode power supply terminal 20 through the switches. Incidentally, the switches may be provided on the negative electrode power supply terminal 21 side.

The operation of the battery device of the fourth embodiment will next be described.

When the voltage of the secondary battery 11 is less than or equal to an overcharge detection voltage set by the overcharge detection circuit 24, the output circuit 43 outputs a negative electrode power supply terminal potential to turn ON the Pch charge control switch 44. In this case, if a load or a charger is connected between the external terminals 18 and 19, current can be made to flow therethrough to bring about a chargeable/dischargeable state.

A detection voltage of the second detection circuit 23 is less than or equal to the overcharge detection voltage and is set to a voltage as high as possible.

When the voltage of the secondary battery 11 is high and greater than or equal to the detection voltage of the second detection circuit 23, the switches 28, 29, and 30 are turned ON to start the overcharge detection circuit 24, the oscillation circuit 29 and the output circuit 43. Further, when the voltage of the secondary battery 11 rises and exceeds the overcharge detection voltage, the overcharge detection circuit 24 outputs a detection signal to output an external terminal voltage input terminal potential from the output terminal 41 of the overcharge detection device 40, thereby turning OFF the Pch charge control switch 44. Then, a charging current path is cut off to protect the secondary battery 11 from overcharging.

When the second detection circuit 23 does not detect the set voltage, the control circuit 25 turns OFF the switches 28, 29, and 30. In the case of this state, the negative electrode power supply terminal potential is outputted from the output terminal 41. By doing this, power consumption of the overcharge detection device 34 can be reduced in most situations that the secondary battery 11 is being used.

As described above, it is possible to realize an overcharge detection device capable of bringing about a state of reducing current consumption of the overcharge detection device except for when the lithium ion secondary battery becomes overcharged, and provide a charging control device and a battery device which are low in power consumption and safe.

What is claimed is:

1. A secondary battery protection circuit comprising:
an overcharge detection device having an overcharge detection circuit and configured to detect overcharging of a secondary battery; and
a charge breaking element configured to interrupt charging to the secondary battery when the overcharging is detected,
the overcharge detection device having a second detection circuit,
the second detection circuit having a detection voltage threshold being identical to a detection voltage threshold of the overcharge detection circuit or in the vicinity of not greater than the detection voltage threshold of the overcharge detection circuit, and
the secondary battery protection circuit being configured to reduce current consumption of the overcharge detection device when a voltage of the secondary battery is less than the detection voltage threshold of the second detection circuit.

2. The secondary battery protection circuit according to claim 1, wherein the charge breaking element comprises a fuse element, a heating resistor, and a control switch, and
wherein the overcharging is detected, the control switch causes a current to flow in the heating resistor to thereby blow out the fuse element and interrupt the charging to the secondary battery.

3. The secondary battery protection circuit according to claim 1, wherein the charge breaking element is an FET, and
wherein when the overcharging is detected, the FET is turned OFF to interrupt the charging to the secondary battery.

4. A battery device comprising a secondary battery protection circuit according to claim 1.
